(19) United States
(12) Patent Application Publication
(10) Pub. No.: US 2014/0167930 A1
(43) Pub. Date: Jun. 19, 2014

(54) CONTROL RADIO COMMUNICATION SYSTEM AND CONTROL RADIO COMMUNICATION METHOD

(71) Applicant: NEC Corporation, Tokyo (JP)

(72) Inventors: YOJI TABUCHI, Tokyo (JP); TOSHIAKI TANAKA, Tokyo (JP); SUGURU ITAGAKI, Tokyo (JP)

(73) Assignee: NEC Corporation, Tokyo (JP)

(21) Appl. No.: 14/109,695

(22) Filed: Dec. 17, 2013

(30) Foreign Application Priority Data
Dec. 19, 2012 (JP) 2012-276811

(51) Int. Cl. G08C 17/02

(52) U.S. Cl. CPC G08C 17/02
USPC 340/12.5

(57) ABSTRACT

A control radio communication system includes a relay station and a child station, each incorporating a radio communication unit further including a receiver and a transmitter. The receiver detects whether or a signal transmitted from the upper layer corresponds to an emergency command. The signal not corresponding to the emergency command is converted into an internal code while the signal corresponding to the emergency command is converted into a High/Low signal to be output via the signal terminal of GPIO. The transmitter of a relay station produces a compacted packet corresponding to the emergency command with a data length shorter than the data length of a packet corresponding to a general command, thus transmitting the compacted packet to the lower layer via radio. Alternatively, the transmitter of a child station produces a packet corresponding to the emergency command, thus transmitting the packet to the lower layer via radio.

### BACKGROUND OF THE INVENTION

1. Field of the Invention

The present invention relates to a control radio communication system and a control radio communication method.

The present application claims priority on Japanese Patent Application No. 2012-276811, the entire content of which is incorporated herein by reference.

2. Description of the Related Art

It is necessary for radio communication systems to implement functions of stopping or disconnecting other radio communication systems at remote places via networks, thus achieving contingency measures against error detection events. In radio communication systems, it is expected to reduce periods between error detecting times and contingency reaction times as low as possible. However, radio communication systems have currently adopted conventional communication protocols focusing on high-speed transmission for large capacities of data (e.g. improvements of throughputs). Conventional communication protocols have not been drafted to satisfy the requirements of securing high-speed responses with small delays to transmit small amounts of data in radio communication systems.

In particular, radio communication systems utilizing different communication protocols between radio communication stations for use in combinations of IP (i.e. Internet Protocol) networks and radio networks may increase processing times of processing signals due to conversion of protocols between radio communication stations. This may cause a bottleneck in reducing delays of response times.

Various technologies have been developed to provide solutions to these problems and disclosed in various papers. For example, Patent Literature Document 1 discloses meta-data transmission via a mesh network. This network system has abilities of selecting a high-speed communication line among a plurality of communication lines inside a mesh network before transmitting data via the mesh network and then transmitting data via the selected high-speed communication line. Additionally, it allows an entertainment device to transmit entertainment information via a high-speed communication line which is selected from among a plurality of communication lines in a mesh network. Moreover, it identifies a high-speed communication line in a mesh network so as to transmit file transfer information via the high-speed communication line.

Patent Literature Document 2 discloses an LDPC coding method (where “LDPC” stands for “Low-Density Parity Check”) which guarantees high-reliability transmission via communication lines possibly incurring irregular attenuation of modulation symbols by way of a pair of LDPC codes. Specifically, it connects code words which are able to select a code block length and to encode data packets. For the purpose of optimizing a coding method, it is necessary to reduce code words so as to secure a plurality of code words used for a desired packet length. Next, code words are punctured or repeatedly punctured to secure a plurality of communication line symbols for each code word. Through reducing code words or repeated puncturing code words, it is possible to minimize overheads while maintaining low coding rates.

Patent Literature Document 3 discloses a medial information transmission method via a life-critical network and a patient portable communication (PPC) instrument. A PPC instrument includes a processor connected to a memory device storing medial firmware and radio firmware, a first radio, a second radio, and a portable housing supporting a power source. The first radio of a PPC instrument communicates with a patient-implanted medical device (PIMD) in accordance with program instructions of medical firmware. The second radio of the PPC instrument communicates with a radio network in accordance with program instructions of radio firmware. For example, the first radio is assigned a stepwise priority level to receive PIMD data. A data transmission mechanism is selected from among a plurality of data transmission mechanisms, which differ from each other, at least based on priority levels. The second radio transmits PIMD data to a radio network by way of the selected data transmission mechanism.

Patent Literature Document 4 discloses a wireless transceiver interface protocol, e.g. a smart transceiver which incorporates wireless protocol stack physics (PHY) and a media access control (MAC) layer to implement a wireless protocol. It can be designed based on a serial peripheral interface (SPI). It is characterized by a specific protocol to control a smart transceiver device and to prepare for bidirectional data transmission with a smart transceiver device. It discloses an example of protocols, commands, and response formats.

Additionally, Patent Literature Document 4 discloses an application program interface (API) which can be used to secure, maintain, and transmit data from/to a smart transceiver device and its system. This API can provide hardware-independent services. Patent Literature Document 4 discloses combinations of services, function calls, configuration setting methods, events, and parameters.

Patent Literature Document 5 discloses a system used to provide telephonic communications and digital media services at homes and offices. It may include a device, serving as an integrated audio, data, and media information center, which is configured to carry out telephonic services and digital media services. This device may directly provide a telephonic communication function using its related handset. This device may install an easy-to-use touch screen interface therein. Additionally, this device may be equipped with a high-performance hardware/software, combined with an integrated system providing high-quality landline telephonic communication services, which is able to transmit high-degree media applications and graphics.

The LDPC coding method of Patent Literature Document 2, which aims to optimize the coding method, is effective for radio communication devices to optimize performances. However, this method may not adequately satisfy functional requirements because control radio networks carrying out 1-to-N communications are required to receive and transmit certain amounts of data at high responses (indicating small delays) with respect to commands of stopping or disconnecting systems in emergency cases such as occurrence of earthquakes.

However, conventional radio communication networks are mainly designed to optimize high-speed communication (or to improve throughputs) but not designed to implement countermeasures (e.g. high-response measures) regarding instantaneous responses with low transmission delays. Recently, automatic pathway construction systems, such as ZigBee, have become dominant, but they need high overheads in communications and suffer from large transmission delays. As an actual circuit configuration, it is possible to design a general-purpose radio module to be used in a specified low power radio communication, as shown in FIG. 4, which is connected to a high-order microprocessor unit (MCU) via a serial interface such as a universal asynchronous receiver-transmitter (UART).

FIG. 4 is a block diagram showing the internal configuration of a conventionally-known radio communication unit, which includes an IP/serial converter module 91 and a radio module 92 in connection with an IP network. The IP/serial converter module 91 includes an MCU which carries out protocol conversion between TCP/IP (i.e. Transmission Control Protocol/Internet Protocol) and serial transmission, thus achieving bidirectional delivery of data between the IP network and the radio module 92. Additionally, the IP/serial converter module 91 is equipped with a control terminal (e.g. GPIO), thus achieving a function of outputting signals to the radio module 92 upon receiving an emergency command from the IP network and a function of generating emergency packets in response to signals supplied from the radio module 92.

The radio module 92 converts the data received via the serial interface into radio communication data so as to transmit it to a certain destination. Upon receiving an emergency command via an input GPIO, the radio module 92 transmits the emergency command reducing radio communication data. Additionally, the radio module 92 receiving an emergency command notifies the IP/serial converter module 91 of reception of the emergency command via an output GPIO.

FIG. 5 is a configuration diagram showing the entirety of a conventionally-known control radio communication system, which includes IP/serial converters 91A, 91B, a parent radio module 92A, and a child radio module 92B. The control radio communication system of FIG. 5 adopting the general-purpose radio module of FIG. 4 needs a processing time to carry out serial communication. The control radio communication system of FIG. 5 whose upper side is connected to the IP network normally needs a processing time for an IP/serial conversion process. For this reason, the control radio communication system may undergo a reduction of response performance due to the processing times.

### CITATION LIST

### Patent Literature Documents

Patent Literature Document 1: Japanese Patent Application Publication No. 2009-543482 (corresponding to WO2008/006066)
Patent Literature Document 2: Japanese Patent Application Publication No. 2010-520666 (corresponding to WO2008/106340)
Patent Literature Document 3: Japanese Patent Application Publication No. 2011-502369 (corresponding to WO2009/032134)
Patent Literature Document 4: Japanese Patent Application Publication No. 2011-505755 (corresponding to WO2009/070460)
Patent Literature Document 5: Japanese Patent Application Publication No. 2012-513169 (corresponding to WO2010/080498)

### SUMMARY OF THE INVENTION

It is an object of the present invention to provide a control radio communication system and a control radio communication method in connection with a relay station and a child station encountering an emergency situation.

A first aspect of the present invention is directed to a control radio communication system including a first radio communication unit and a second radio communication unit. The first radio communication unit further includes a first receiver which detects whether or a signal transmitted from the upper layer corresponds to an emergency command and in which the signal not corresponding to the emergency command is converted into an internal code while the signal corresponding to the emergency command is converted into a High/Low signal to be output via the signal terminal attached to GPIO, and a first transmitter which produces a packet corresponding to the emergency command with a data length shorter than a data length of a packet corresponding to a general command, thus transmitting the packet via radio. The second radio communication unit further includes a second receiver which detects whether or a signal transmitted from the first radio communication unit corresponds to an emergency command and in which the signal not corresponding to the emergency command is converted into an internal code while the signal corresponding to the emergency command is converted into a High/Low signal to be output via the signal terminal attached to GPIO, and a second transmitter which produces a packet corresponding to the emergency command, thus transmitting the packet to the lower layer via radio.

A second aspect of the present invention is directed to a radio communication unit adapted to a relay station. The radio communication unit of a relay station includes a receiver which detects whether or a signal transmitted from the upper layer corresponds to an emergency command and in which the signal not corresponding to the emergency command is converted into an internal code while the signal corresponding to the emergency command is converted into a High/Low signal to be output via the signal terminal attached to GPIO, and a transmitter which produces a packet corresponding to the emergency command with a data length shorter than a data length of a packet corresponding to a general command, thus transmitting the packet to the lower layer via radio.

A third aspect of the present invention is directed to a radio communication unit adapted to a child station. The radio communication unit of a child station includes a receiver which detects whether or a signal transmitted from the upper layer corresponds to an emergency command and in which the signal not corresponding to the emergency command is converted into an internal code while the signal corresponding to the emergency command is converted into a High/Low signal to be output via the signal terminal attached to GPIO, and a transmitter which produces a packet corresponding to the emergency command, thus transmitting the packet to the lower layer via radio.

A fourth aspect of the present invention is directed to a control radio communication method including a first reception step, a first transmission step, a second reception step, and a second transmission step. The first reception step detects whether or a signal transmitted from the upper layer corresponds to an emergency command so as to convert the signal not corresponding to the emergency command into an internal code while converting the signal corresponding to the emergency command into a High/Low signal to be output via the signal terminal attached to GPIO. The first transmission step produces a packet corresponding to the emergency command with a data length shorter than a data length of a packet corresponding to a general command, thus transmitting the packet via radio. The second reception step detects whether or the packet transmitted via the first transmission step corresponds to the emergency command so as to convert the packet not corresponding to the emergency command into an internal code while converting the packet corresponding to the emergency command into a High/Low signal to be output via the signal terminal attached to GPIO. The second transmission step produces a packet corresponding to the emergency command so as to transmit the packet to the lower layer via radio.

As described above, the control radio communication system of the present invention is designed to automatically produce a compacted packet, corresponding to an emergency command, with a data length shorter than a data length of a general command. This makes it possible to secure high-response performance with a small delay in transmitting an emergency command which stops system operations or which disconnects systems from networks in response to emergencies such as the occurrence of earthquakes.

### BRIEF DESCRIPTION OF THE DRAWINGS

These and other objects, aspects, and embodiments of the present invention will be described in more detail with reference to the following drawings.

FIG. 1 is a configuration diagram showing the entirety of a control radio communication system according to a preferred embodiment of the present invention

FIG. 2 is a schematic diagram showing the entirety of a radio communication network adopting the control radio communication system.

FIG. 3 shows a detailed data configuration of a compacted packet for use in an emergency command.

FIG. 4 is a block diagram showing the internal configuration of a conventionally-known radio communication unit.

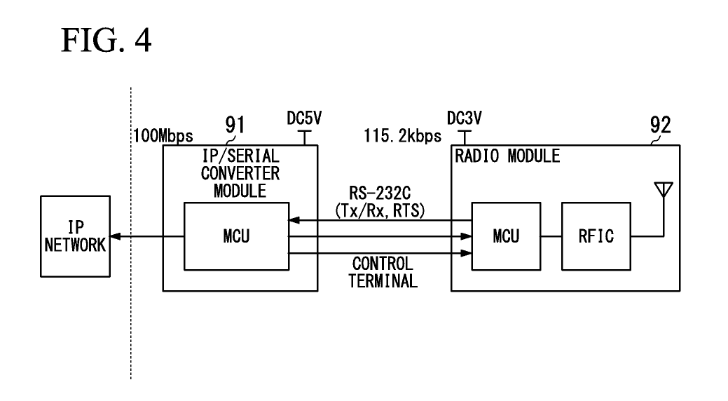

FIG. 5 is a configuration diagram showing the entirety of a conventionally-known control radio communication system.

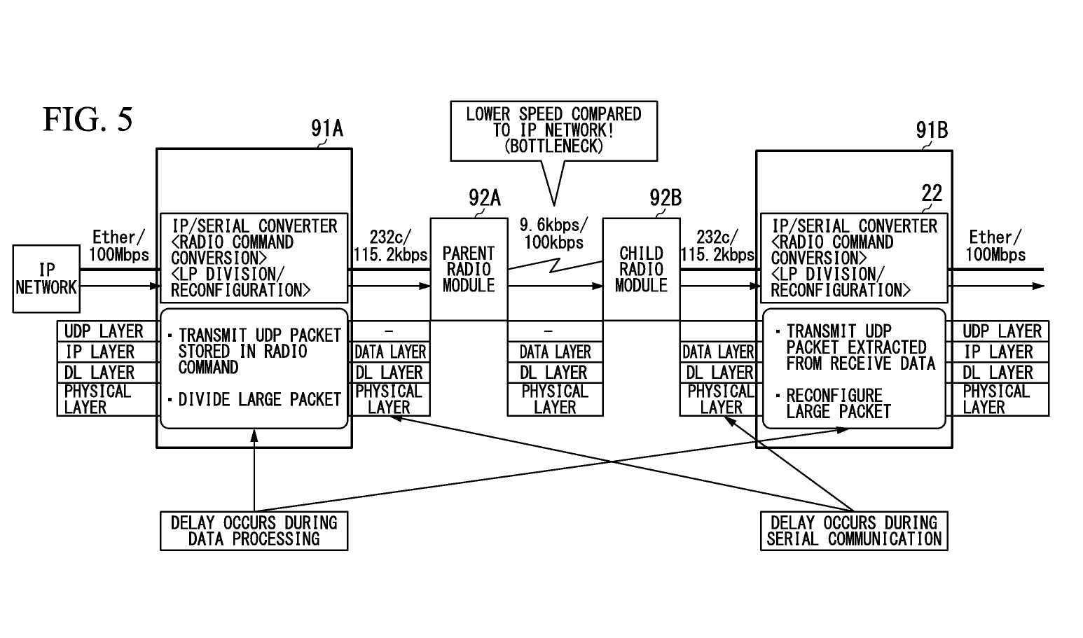

### DESCRIPTION OF THE PREFERRED EMBODIMENT

The present invention will be described in further detail by way of examples with reference to the accompanying drawings.

The present invention aims to achieve high-speed response required in a control network needing a specified command (or an emergency command) with respect to an integrated system combining devices which differ from each other in terms of communication quality (i.e. transmission performance) and protocols (e.g. an IP network and a radio network).

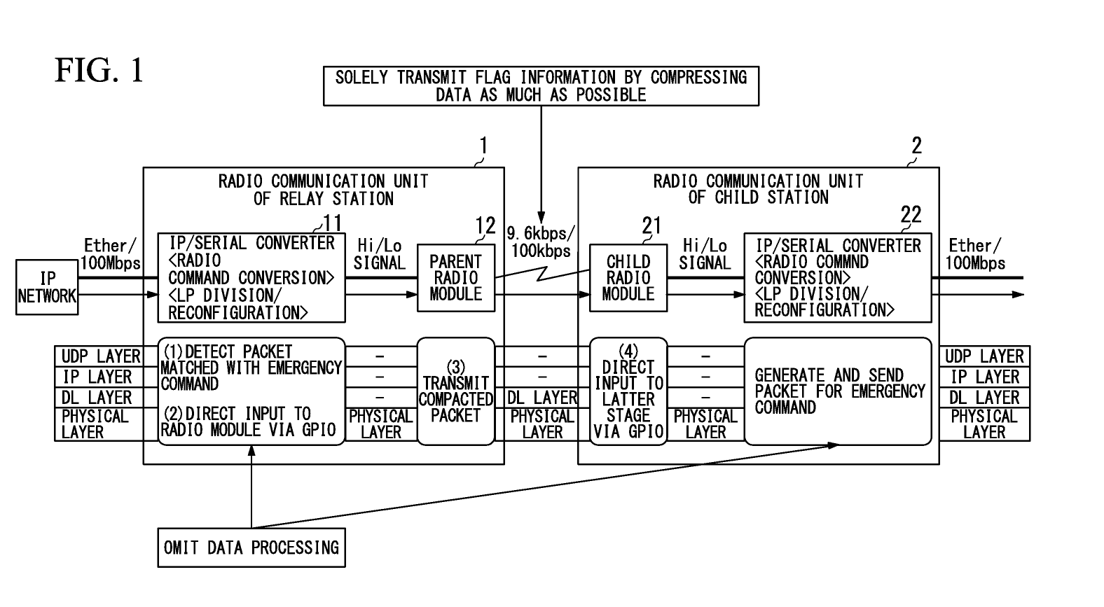

FIG. 1 is a configuration diagram showing the entirety of a control radio communication system according to a preferred embodiment of the present invention. The control radio communication system includes a radio communication unit 1 of a relay station (e.g. a first radio communication unit) and a radio communication unit 2 of a child station (e.g. a second radio communication unit).

The radio communication unit 1 of a relay station includes an IP/serial converter 11 (e.g. a first receiver) and a parent radio module 12 (e.g. a first transmitter). The radio communication unit 2 of a child station includes a child radio module 21 (e.g. a second receiver) and an IP/serial converter 22 (e.g. a second transmitter). Each of the IP/serial converts 11 and 22 includes a microprocessor (MPU).

Next, the overall function of the control radio communication system will be described below. In response to an emergency command requiring high response performance, the control radio communication system utilizes a special pathway using a signal line attached to hardware and provides a specific mode in a lower layer of a radio protocol, thus achieving high response performance. Specifically, upon receiving a general command, the IP/serial converter 11 (serving as a parent station) carries out IP/serial conversion on the received general command while generating and recording a radio-module transmission command.

Upon receiving an emergency command, however, the IP/serial converter 11 does not carry out IP/serial conversion and does not generate and record a radio-module transmission command but transmit a High/Low signal (i.e. a Hi/Lo signal) to the parent radio module 12 via a signal terminal attached to GPIO. Upon receiving an emergency command, the parent radio module 12 transmits a compacted packet (whose data portion is compressed) to the child radio module 21. Details of a compacted packet will be described later.

Upon receiving a compacted packet, the child radio module 21 directly sends the High/Low signal (which is transmitted via the signal terminal attached to GPIO) to the IP/serial converter 22. Upon receiving the High/Low signal, the IP/serial converter 22 generates a packet for use in an emergency command so as to send it to the IP network. At the same time, the currently serving station receiving an emergency command activates an emergency function (details of which are not discussed here) to carry out predetermined emergency measures such as stoppage and disconnection, thus achieving high-response performance in communication.

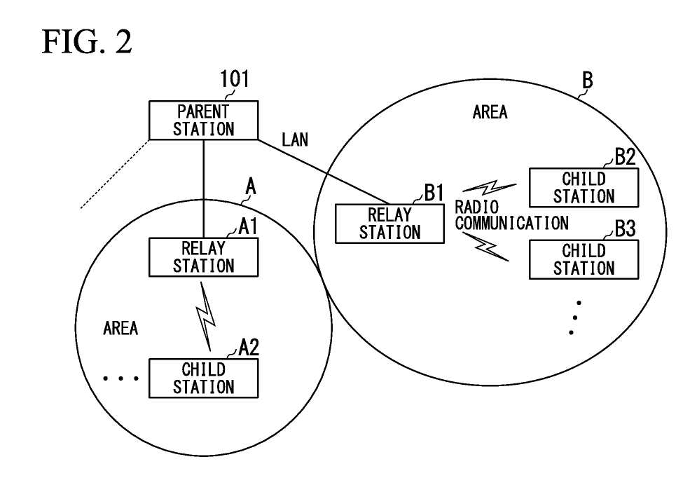

FIG. 2 is a schematic diagram showing the entirety of a radio communication network adopting the control radio communication system. The control radio communication system controls a plurality of child stations via a relay station for each area by way of a parent station. Specifically, the radio communication network is configured such that a parent station 101 is connected to a relay station A1 communicating with a child station A2 via radio in an area A and connected to a relay station B1 communicating with child stations B2, B3 via radio in an area B. The parent station carries out various control operations on child stations via relay stations. Additionally, the parent station transmits an emergency command to a child station so as to implement an emergency process to stop the operation of the child station or disconnect the child station.

Specifically, the parent station 101 carries out a general process to transmit a control command to each of the child stations A2, B2, B3 via the relay stations A1 and B1 in the areas A and B. The parent station 101 has a function of independently detecting an error occurring inside or outside the system thereof and a function of receiving a notification of an error occurring inside or outside the system thereof. Additionally, the parent station 101 has a function of sending an emergency command to all the relay stations or a relay station of a specific area in an emergency mode. Each relay station has a function of receiving or sending a command with each child station in each area. Additionally, each relay station includes a radio communication unit to communicate with each child station in each area.

Each child station is able to execute a control command which is supplied from each relay station connected thereto via radio. With reference to an emergency command, each child station is able to carry out an emergency measure to stop the operation each child station or disconnect each child station from the network. Each child station includes a radio communication unit to communicate with each relay station connected thereto via radio. The radio communication unit 1 of FIG. 1 can be applied to each relay station, while the radio communication unit 2 of FIG. 2 can be applied to each child station.

With reference to FIGS. 1 and 2, the operation of the control radio communication system will be described below. In response to a problem causing a critical damage to the system due to an external factor (e.g. an environmental error) or a system error, the parent station 101 specifies an area needing an emergency measure so as to transmit an emergency command to each relay station in the specified area via a LAN. Thus, the control radio communication system starts to carry out the following operation on each relay station and each child station.

In the specified area, each relay station receiving an emergency command sends a packet to the radio communication unit 1, thus activating a special process corresponding to the emergency command (which aims to achieve a small delay in communication) between the radio communication units of each relay station and each child station. Specifically, in the radio communication unit 1 of each relay station receiving a packet according to the TCP/IP, the IP/serial converter 11 detects the packet corresponding to the emergency command so as to notify the parent radio module 12 of the reception of the emergency command by way of a High/Low signal via GPIO.

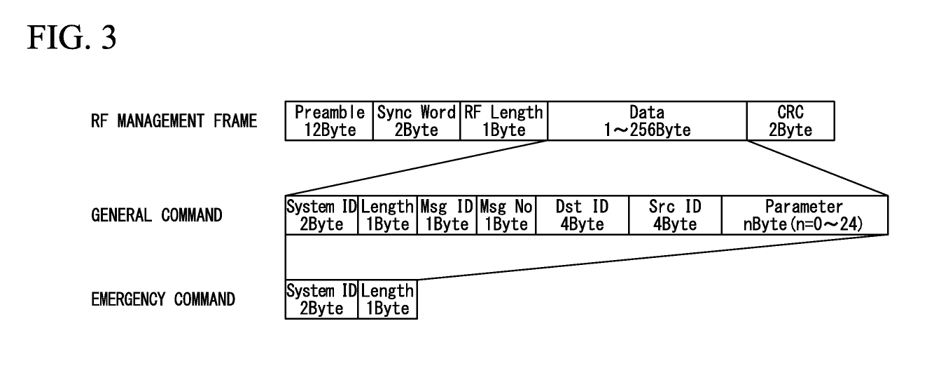

Upon receiving the emergency command input via the signal line attached to GPIO, the parent radio module 12 transmits a compacted packet (in which a data portion is compressed) to the child radio module 21. Details of a compacted packet will be described with reference to FIG. 3. FIG. 3 shows a detailed data configuration of a compacted packet corresponding to an emergency command. Generally speaking, a control command (or a general command) is configured such that maximally 256 bytes are stored in a Data portion of an RF (Radio Frequency) management frame. The present embodiment reconfigures a general command to store four or more bytes. Additionally, the present embodiment determines an emergency command having a data length of three bytes. Since an emergency command is fixed to a data length of three bytes, the child radio module 21 receiving an RF management frame is able to easily recognize whether or not the received data is an emergency command.

Upon receiving an emergency command, the child radio module 21 sends the emergency command to the IP/serial converter 22 by way of a High/Low signal output via GPIO. The IP/serial converter 22 generates a packet for use in the emergency command and send it to the IP network. At the same time, the emergency function of the child station receiving the packet executes the predetermined emergency measure to stop the operation of the child station or disconnect the child station from the network.

Owing to the foregoing configuration of the control radio communication system, the IP/serial converter 11 of the radio communication unit 1 identifies the emergency command to notify it to the radio module 12 by way of the signal line (or hardware) normally attached to GPIO. This enables the emergency command to be transmitted with a small delay compared to that of a normal communication; hence, it is possible to rapidly execute a countermeasure against the emergency command. In response to an emergency command, the conventional system converts TCP/IP packets into serial data by way of the software processing using an MCU (i.e. a microprocessor), whereby this conversion process may solely reduce the communication speed.

In contrast, the control radio communication system of the present embodiment is characterized by reducing a data length in communication between radio stations, wherein it is possible to transmit an emergency command solely by way of the data length of an RF frame; hence, it is possible to identify the emergency command with ease. Therefore, the present invention demonstrates an effect of reducing the transmission time.

Additionally, the control radio communication system of the present embodiment is characterized by that, upon receiving an emergency command, the child radio module 21 notifies the emergency command to the IP/serial converter 22 via a signal line attached to the GPIO which is preinstalled hardware, wherein the IP/serial converter 22 is allowed to generate a packet for use in the emergency command. In this sense, the present embodiment demonstrates an effect of relaying packets with a small delay.

In the control radio communication system of the present embodiment, a plurality of microprocessors (MCU) is incorporated into the IP/serial converters 11, 22 and the radio modules 12, 21 in the radio communication units 1, 2, thus achieving serial communication or communication via GPIO. It is possible to modify the present invention to integrate a plurality of microprocessors (MCU) into a single MCU. This modification is not designed to implement a countermeasure against delays via GPIO but to implement a function of generating a compacted packet for an RF frame with the MCU recognizing an emergency command. Thus, it is possible to improve a response function against a delay due to an emergency command.

The control radio communication system of the present embodiment can be applied to various fields. For example, it can be applied to a system which needs to compulsorily close hydraulic valves in a plant in synchronism with an emergency report regarding the occurrence of earthquakes. Additionally, it can be preferably applied to a computer system which needs to carry out high-response controls in emergency when compulsorily shut down networks for the purpose of preventing expansion of computer virus infection.

The control radio communication system of the present embodiment involves a first radio communication stage and a second radio communication stage. The first radio communication stage includes a first reception step and a first transmission step. The first reception step detects whether or not a signal transmitted from the upper layer corresponds to an emergency command. When the signal does not correspond to the emergency command, the signal is converted into an internal code. When the signal corresponds to the emergency command, a High/Low signal is generated and output via a signal terminal attached to GPIO. The first transmission step produces a compacted packet corresponding to an emergency command by reducing the length of a data portion to be shorter than that of a packet corresponding to a general command, thus transmitting the compacted packet to the lower layer via radio.

The second radio communication stage includes a second reception step and a second transmission step. The second reception step detects whether or not a signal transmitted from the first radio communication stage corresponds to an emergency command. When the signal does not correspond to the emergency command, it is converted into an internal code. When the signal corresponds to the emergency command, a High/Low signal is generated and output via a signal terminal attached to GPIO. The second transmission step produces a packet corresponding to an emergency command so as to transmit the packet to the lower layer via radio.

Lastly, the present invention is not necessarily limited to the foregoing embodiment, which can be further modified in various ways within the scope of the invention as defined by the appended claims.

What is claimed is:

1. A control radio communication system comprising:
a first radio communication unit, further including a first receiver which detects whether or a signal transmitted from an upper layer corresponds to an emergency command and in which the signal not corresponding to the emergency command is converted into an internal code while the signal corresponding to the emergency command is converted into a High/Low signal to be output via a signal terminal attached to a GPIO, and a first transmitter which produces a packet corresponding to the emergency command with a data length shorter than a data length of a packet corresponding to a general command, thus transmitting the packet via radio; and
a second radio communication unit, further including a second receiver which detects whether or a signal transmitted from the first radio communication unit corresponds to an emergency command and in which the signal not corresponding to the emergency command is converted into an internal code while the signal corresponding to the emergency command is converted into a High/Low signal to be output via a signal terminal attached to a GPIO, and a second transmitter which produces a packet corresponding to the emergency command, thus transmitting the packet to a lower layer via radio.

2. The control radio communication system according to claim 1, wherein the upper layer is an Internet, and wherein the first receiver has an IP protocol.

3. The control radio communication system according to claim 1, wherein the packet corresponding to the emergency command has a data length of three bytes.

4. A radio communication unit adapted to a relay station, comprising:
a receiver which detects whether or a signal transmitted from an upper layer corresponds to an emergency command and in which the signal not corresponding to the emergency command is converted into an internal code while the signal corresponding to the emergency command is converted into a High/Low signal to be output via a signal terminal attached to a GPIO; and
a transmitter which produces a packet corresponding to the emergency command with a data length shorter than a data length of a packet corresponding to a general command, thus transmitting the packet to a lower layer via radio.

5. A radio communication unit adapted to a child station, comprising:
a receiver which detects whether or a signal transmitted from an upper layer corresponds to an emergency command and in which the signal not corresponding to the emergency command is converted into an internal code while the signal corresponding to the emergency command is converted into a High/Low signal to be output via a signal terminal attached to a GPIO; and
a transmitter which produces a packet corresponding to the emergency command, thus transmitting the packet to a lower layer via radio.

6. A control radio communication method comprising:
a first reception step of detecting whether or a signal transmitted from an upper layer corresponds to an emergency command, converting the signal not corresponding to the emergency command into an internal code, and converting the signal corresponding to the emergency command into a High/Low signal to be output via a signal terminal attached to a GPIO;
a first transmission step of producing a packet corresponding to the emergency command with a data length shorter than a data length of a packet corresponding to a general command, thus transmitting the packet via radio;
a second reception step of detecting whether or the packet transmitted via the first transmission step corresponds to the emergency command, converting the packet not corresponding to the emergency command into an internal code, and converting the packet corresponding to the emergency command into a High/Low signal to be output via a signal terminal attached to a GPIO; and
a second transmission step of producing a packet corresponding to the emergency command, thus transmitting the packet to a lower layer via radio.

7. A control radio communication system comprising:
a parent station;
at least one relay station connected to the parent station; and
at least one child station which is connected to the relay station via radio, wherein the relay station includes a radio communication unit which produces a compacted packet with a short data length which is determined in advance upon receiving an emergency command from the parent station, and
wherein the child station includes a radio communication unit which produces a packet upon receiving the emergency command from the relay station.
